(19) United States
(12) Patent Application Publication
(10) Pub. No.: US 2016/0345265 A1
(43) Pub. Date: Nov. 24, 2016

(54) LOW POWER WIDE AREA NETWORK

(71) Applicant: Senaya, Inc., Framingham, MA (US)

(72) Inventors: Brian Lee, Boston, MA (US); Hyoseok Yi, Cambridge, MA (US)

(21) Appl. No.: 15/093,969

(22) Filed: Apr. 8, 2016

Related U.S. Application Data
(60) Provisional application No. 62/164,253, filed on May 20, 2015.

(51) Int. Cl. H04W 52/02; H04W 64/00

(52) U.S. Cl. CPC H04W 52/0235; H04W 64/00; H04W 52/0254; H04W 4/06

(57) ABSTRACT

A long range, low power, low cost, wireless communication system that has a location determination capability (location fix) and optionally a direct control capability (“On Demand” control) at optimal power and communication resource overhead. The system can be used for device initiated (DI) communications and for network initiated (NI) communications. The location fix can be an assisted location fix, using a GPS-assisted device, a WiFi-assisted device, or both a GPS- and a WiFi-assisted device. For situations when neither WiFi nor GPS are available, a network-based location fix provides location information, which can be augmented by home cell (HC) ranging information. Various embodiments of the system and methods related to the systems are provided.

### CROSS-REFERENCE

This application claims priority under 35 U.S.C. 119(e) to U.S. provisional application 62/164,253, filed May 20, 2015, the entire disclosure of which is incorporated herein for all purposes.

### FIELD OF THE DISCLOSURE

The present disclosure is directed to low power wide area networks, particularly, a low power wide area network configured to determine its localization and direct control.

### BACKGROUND

Internet of Things (IoT) is the network of physical objects—devices, vehicles, buildings and other items embedded with electronics, software, sensors, and network connectivity—that enables these objects to collect and exchange data, and already prevails in our daily life with billions of connected devices. Industry analysts expect that IoT will outpace the cellphone industry by as much as 10 to 50 times in the number of connected devices, reaching more than 50 billion connected devices in the next 5-10 years. However, current communication infrastructure, which is built primarily on cellular technologies, is designed for human-to-human communication. In order to support communication between physical objects or things, there is a distinct need for a new type of a wireless communication technology that supports the massive number of connected devices at much lower power and cost.

Low Power Wide Area Network (LP_WAN) was introduced as a wireless communication solution with long range communication distance, low power consumption, and low device cost. Various types of LP_WAN are currently available. Some of the popular variants of the technology are ‘ultra narrow band’ (“UNB”, e.g., from SigFox), ‘long range LP_WAN’ (“LoRa”, e.g., from SemTech Corporation), and ‘cellular IoT’ (“CIoT”, e.g., from Huawei Technologies Co., Ltd.).

LP_WAN is, however, constrained in its data rate (typically less than a few kbps), its payload (typically less than a couple of hundred bytes), and its transmission bandwidth (typically less than 500 kHz). Due to these constraints, LP_WAN is mainly used for low data transmission applications such as asset monitoring, street light control, agricultural monitoring, etc., or other applications where a device merely sends a short message (typically less than 12 bytes) to the network as a one-way communication with limited acknowledgement. The lack of bi-directional communication capabilities limits the application of LP_WAN, as does a lack of any location determination features.

### SUMMARY

This disclosure is directed to a long range, low power, low cost, wireless communication system that has a location determination capability (location fix) and a direct control capability (“On Demand” control) at optimal power and communication resource overhead. The system includes a network and an array of devices. Various embodiments of the system and methods related to the systems are provided.

For example, a location fix is made with a “categorized group wake-up mechanism” to maximize the device capacity in combination with a hybrid location fix method. The location fix can be done by a device or by the network, such as when data transmission is desired. Furthermore, the location fix technology adopts a dynamic hierarchical priority algorithm to provide accurate location information at fixed resources. A location fix can be an assisted location fix, using a GPS (Global Positioning System)-assisted device, a WiFi-assisted device, or both a GPS- and a WiFi-assisted device. For situations when neither WiFi nor GPS are available, a network-based location fix provides location information, which can be augmented by home cell (HC) ranging information.

The “categorized group wake-up mechanism” enables a direct control or “On Demand” control of the location fix, which minimizes unwanted data collection events, thus saving power and enhancing device node density within the system.

A truncated fingerprinting method is also provided that can be used with the LP_WAN of the disclosure. In such a method, no more than 2 WiFi signals are selected as a main group, and then no more than 4 WiFi signals are selected as a sub group, according to a received signal strength indication (RSSI) value.

Further, a sequence of a device initiated (DI) communication is provided that uses either a network-based location fix or an assisted location fix. A sequence of a network initiated (NI) communication is provided that uses either a network-based location fix or an assisted location fix.

A combination of both location fix technology and “On Demand” control extends the application landscape of LP_WAN technology to asset monitoring, asset tracking, event management, people tracking, home automation, smart cities, smart securities, smart energy, etc. in both private and public network infrastructures.

One particular embodiment provided in this disclosure is an LP_WAN solution comprising a plurality of primary assisted location fix capabilities, each assisted location fix being a standalone location fix or integrated with another location fix, and a secondary LP_WAN-based location fix, so called a network-based location fix, and a secondary home cell-based location ranging. The assisted location fix capabilities are any or all of a WiFi-assisted location fix, a GPS-assisted location fix, a Low energy Bluetooth (LBE) assisted location fix, and/or other LAN or PAN assisted location fix. In some embodiments, the hierarchy and priority of the location fix are pre-programmed by each device and embedded in a firmware format using a location fix protocol logic or algorithm as described herein.

Another particular embodiment is a LP_WAN solution comprising a plurality of communication options, being a user requested, network calculated method (URNC), or a network requested, network calculated method (NRNC). In some embodiments, the URNC can be triggered by a time based ping (TBP), a motion based ping (MBP), or an event based ping (or so called “Smart Ping”); that is, the URNC can be based on time, motion, or an expected event. In other embodiments, the NRNC can be made by waking up a device using a device synchronization (DS) process, that is done by a paging channel method, a fixed pulse length and period, or a categorized group wake-up method to maximize the node capacity. An overlapped pulse follows a pre-determined priority protocol according to its latency requirement. The DS process can be used to assign a home cell (HC). Additionally or alternately, the DS process may be in sleep mode when there is no motion in a particular solution. An “On Demand” or direct control can be enabled.

The solutions can be implemented on a device such as a “smartphone”, for example, an iOS based iPhone or an Android based Smartphone. An LP_WAN dongle using a parallel interface such as USB or audio jack can be used, and the LP_WAN can be embedded in the smartphone.

The device, whether a smartphone or other GPS and/or WiFi enabled device, can be categorized into one of multiple groups depending on latency requirement priority. The groups of devices are used with a wake-up architecture to avoid interference among the device transmissions.

These and various other features and advantages will be apparent from a reading of the following detailed description

### BRIEF DESCRIPTION OF THE DRAWING

The disclosure may be more completely understood in consideration of the following detailed description of various embodiments of the disclosure in connection with the accompanying drawing, in which:

FIG. 1A is a schematic diagram of a device initiated (DI) call; FIG. 1B is a schematic diagram of a network initiated (NI) call.

FIG. 2 is a schematic diagram of a network illustrating a home cell assignment.

FIG. 3 is a graphical representation of a device synchronization (DS) pulse in relation to a registering (R) ping mechanism.

FIG. 4A is a graphical representation of categorized group wake-up architecture; FIG. 4B is a graphical representation of a subgroup of wake-up architecture.

FIG. 5 is a schematic diagram of a direct control method or “On Demand” control.

FIG. 6 is a schematic diagram illustrating cell phone integration with LP_WAN, the diagram illustrating a dongle solution and an embedded solution.

FIG. 7 is a diagram illustrating location fix topology in various locations.

FIG. 8 is a schematic diagram illustrating assisted location fix methods, including GPS-assisted and WiFi-assisted fix methods.

FIG. 9A is a schematic diagram illustrating a WiFi fingerprinting process; FIG. 9B is a schematic diagram illustrating a normal WiFi information packet.

FIG. 10 is a stepwise sequence diagram for a location fix algorithm for a WiFi-primary and GPS-secondary enabled device.

FIG. 11 is a stepwise sequence diagram for a location fix algorithm for a GPS-primary and WiFi-secondary enabled device.

FIG. 12 is a stepwise sequence diagram for a location fix algorithm for a WiFi-enabled device.

FIG. 13 is a stepwise sequence diagram for a location fix algorithm for a GPS-enabled device.

FIG. 14 is a schematic diagram of a device initiated (DI) call using a network-based location fix method.

FIG. 15 is a schematic diagram of a device initiated (DI) call using an assisted location fix method.

FIG. 16 is a schematic diagram of a network initiated (NI) call using a network-based location fix method.

FIG. 17 is a schematic diagram of a network initiated (NI) call using an assisted location fix method.

FIG. 18 is a schematic diagram of an IoT communication stack using LP_WAN as a main building block in conjunction with conventional cellular and internet layers.

FIG. 19 is a schematic diagram of various use cases showing integration of LP_WAN with other wireless communication schemes.

### DETAILED DESCRIPTION

This disclosure is directed to a long range, low power, low cost, wireless communication system, particularly adapted for IoT (internet of things) that has a location determination capability (location fix) and a direct control capability (“On Demand” control) while operating at optimal power consumption.

In the following description, reference is made to the accompanying drawing that forms a part hereof and in which are shown by way of illustration at least one specific embodiment. The following description provides additional specific embodiments. It is to be understood that other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

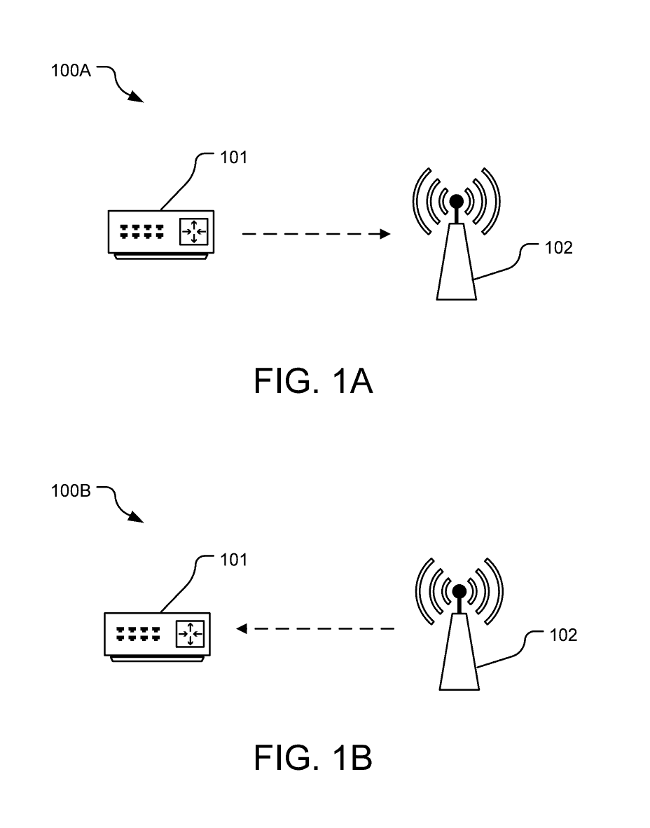

FIGS. 1A and 1B show two types of communication options available for IoT; FIG. 1A shows a system 100A for a device initiated (DI) call and FIG. 1B shows a system 100B for a network initiated (NI) call. In each system 100A 100B, a wireless device 101 is in communication with a network 102, in these figures illustrated as a cell tower. Device 101 can be any device wirelessly connected to the network, the device either sending or receiving data to the network; examples of such devices include cellular phones (e.g., “smartphones”), watches (e.g., “smartwatches”), security monitors and baby monitors, house utility controls (e.g., thermostat, lights, coffee maker, etc.), door locks, personal fitness monitors, etc. In most applications, device 101 is fairly small, portable and powered by batteries whereas network 102 is stationary, hardwired to a power line. It is desired to minimize the power consumption of each device 101 in order to extend its battery life and thus the usable life of the device.

A DI call is a call between device 101 and network 102 that is initiated by device 101. The DI call can be initiated by one or a combination of a user-initiated data transmission or “ping”, a time based ping, a motion based ping, or an event based ping where the device makes a decision on each initiation of a ping.

Similarly, an NI call between device 101 and network 102 that is initiated by network 102 (or other similar network such as a gateway or metro cell). In order to receive the call, device 101 has to be active or “awake.”

Although the term “call” is used, a “call” is any exchange of data between device 101 and network 102. Both a DI call and an NI call can be selectively chosen or combined together according to each use case, as appropriate, and the overall system should be able to support both options at the same time.

For both systems 100A, 100B, network 102 includes a home cell (HC) for each device 101 to which and from which a call can be made. A network 102 with multiple devices 101 thus may have multiple HCs.

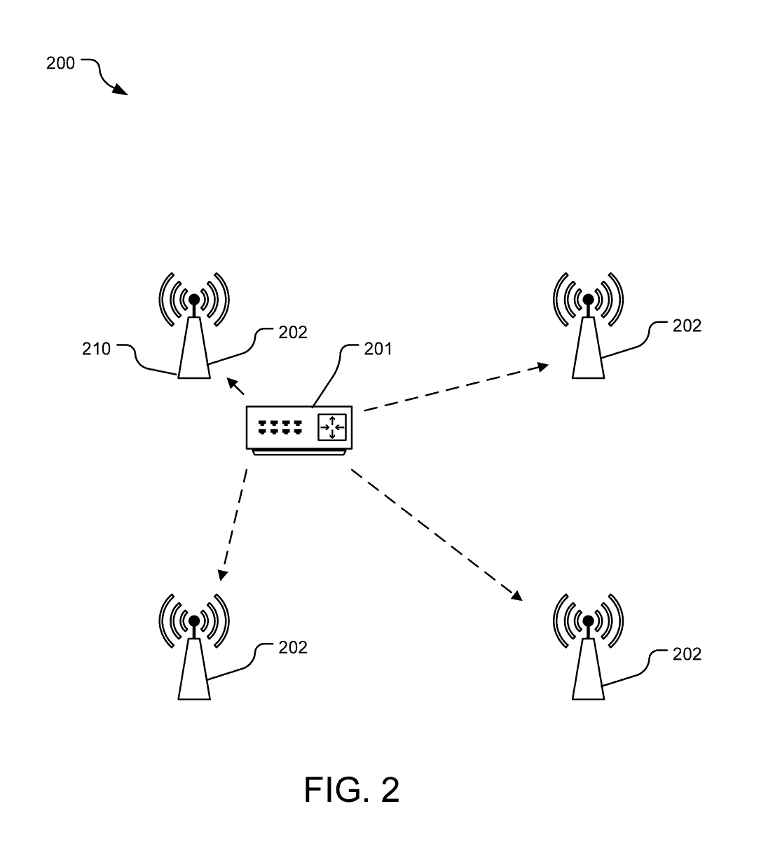

Shown in FIG. 2 is a system 200 that has a device 201 and multiple networks 202, one of which is a home cell (HC) 210. Although each illustrated ‘tower’ in FIG. 2 is referred to as a ‘network’, together the multiple towers form ‘a network;’ thus the use of the term ‘network’ herein can refer to either a single tower (or network access) or to multiple towers (or access points).

HC 210 is the nearest network available to device 201, and is assigned by comparing RF received signal strength indications (RSSI) from the multiple networks 202. The designation of HC 210 will change as device 201 physically moves in relation to networks 202, as a network's strength decreases or if a network 202 goes down or otherwise inactivates.

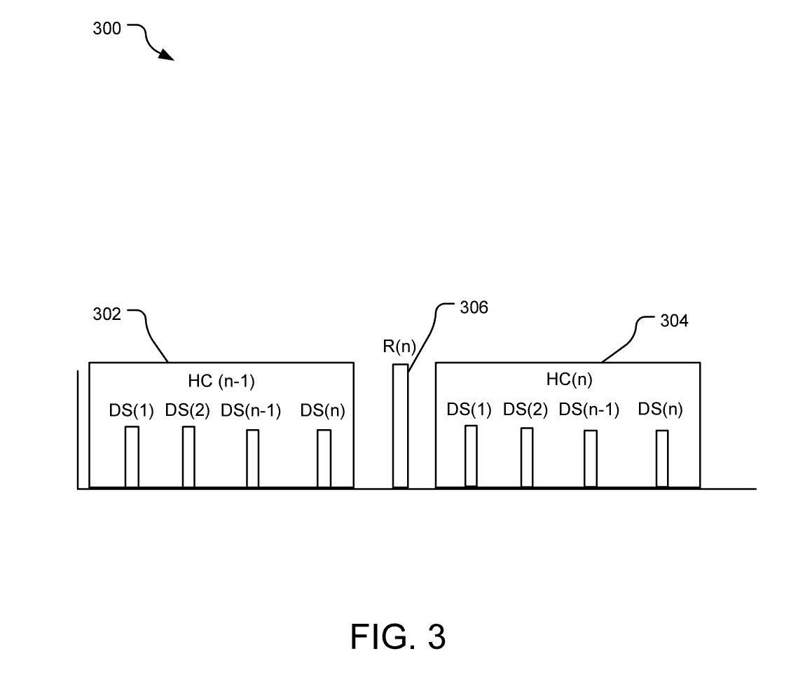

FIG. 3 illustrates a device synchronization (DS) methodology 300 for two home cell regions, HC(n−1) 302 and HC(n) 304, and a registering ping R(n) 306. Each device synchronization pulse DS(n), e.g., DS(1), DS(2) DS(n−1), DS(n), for both HC(n−1) 302 and HC(n) 304, has a pulse period “P” and a pulse length “T.”

A synchronization signal can be sent to the device (e.g., device 201) by the home cell (e.g., HC 210) in a scheduled manner or when the device wakes up or activates. In reply, a DS(n) is issued by the device, after which the device listens for a subsequent signal from the home cell or network. During the synchronization process, the device is turned on and it receives LP_WAN signals from the network, without transmitting any signal to the network.

The receiving current for the synchronization process is low, typically less than 10 mA, and the pulse length can be as short as, e.g., 5 ms, although longer pulse lengths can alternately be used. Therefore, the total power consumed by the device for the synchronization process is low. The period “P” and pulse length “T” should be selected so that the device does not consume excessive power while the latency is minimized. The duty factor (DF=T/P) is recommended to be in between 1% and 0.1% for most applications.

As an example, a period “P” of 5 ms and a pulse length “T” of 5 s has a duty factor of 0.1%. Annual Power Consumption can be calculated from the receiving current for the synchronization process (e.g., 10 mA) times duty factor DF (e.g., 0.1%) times the number of hours per year. For this example, the Annual Power Consumption is 87.6 mAH for 0.1% duty factor.

When a wake-up call is received by the device via any of the DS pulses from home cell HC(n−1) 302, the device wakes up and starts communicating with the network. The device receives a synchronization signal from the network during an acknowledgement (ACK) process. When a change in home cell signal is detected during a DS process, the device sends a home cell registering ping R(n) 306 to a new home cell HC(n) 304, thus acknowledging the new home cell. The device may receive a synchronization signal from the network during an ACK process. In some embodiments of the DI communication, the DS process may be on hold when no motion is detected. This will substantially save power consumption by the device. In situations with DI communication and a static asset monitoring case, the DS process is not turned on at all since there is no motion, and a permanent home cell is assigned at the beginning.

Table 1 shows an example categorized wake-up process architecture, in which devices (e.g., devices 201) are categorized into multiple groups depending on each device's latency requirement priority. In Table 1, each device is assigned to a specific category or “Group” depending on the device's latency tolerance and priority. In Table 1, the pulse length (P) and period (T) are exemplary, the duty factor (DF) is T/P, the number of nodes is exemplary, as are the comments.

TABLE 1

| | Pulse | Period (T) | Duty | # of | |
|---|---|---|---|---|---|
| | length (P) | (latency) | factor | nodes | Comments |
| Group 0 | 0 | n/a | 0 | n/a | URNC, TBP, |
| | | | | | MPB, EBP |
| Group 1 | 1000 ms | 1000 s | 0.1% | 200 | high latency |
| . . . | | | | | |
| Group n − 1 | 100 ms | 10 s | 1% | 20 | short battery life |
| Group n | 10 ms | 1 s | 1% | 2 | Premium, low |
| | | | | | latency |

In Table 1, “Group 0” is a group that does not require any wake-up call, and a call is made by the device (i.e., DI call) using a user requested network (UNRC) with a time based ping (TBP), motion based ping (MBP), and/or event based ping (EBP). “Group 1” has those devices that are most latency tolerant, devices such as fixed assets with infrequent reporting requirements, where the latency may be very long, e.g., minutes, hours, or days. “Group n” has those devices where a short latency is critical such as security, critical asset tracking, etc. “Group n−1” is intermediate to Group 1 and Group n, and has, e.g., those devices that have a short battery life. Such a technique for categorizing the devices is highly beneficial when the system (e.g., system 200 of FIG. 2) has a large number of node devices.

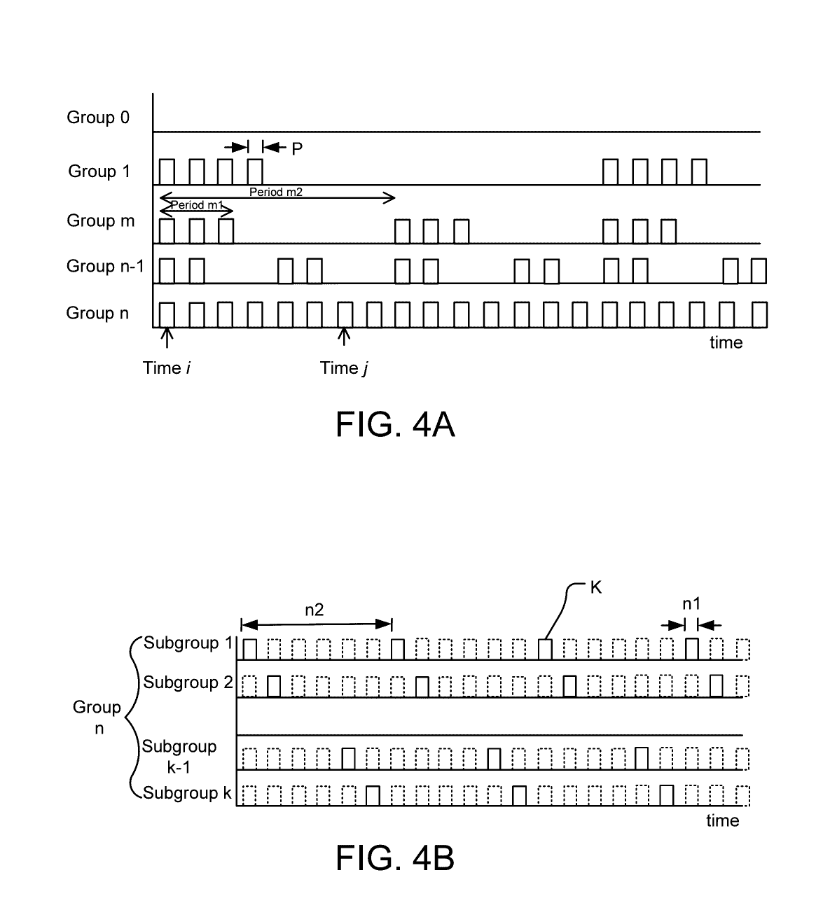

Turning to FIG. 4A, DS pulses for various devices (e.g., devices 201) that have been categorized into multiple groups depending on each device's latency requirement priority, similar to Table 1, are shown. The groups of FIG. 4A are similar to the groups of Table 1, although not exactly the same.

Grouping of the devices, as described above in reference to FIGS. 4A and 4B, can be achieved in multiple ways. The grouping can be encoded into the device itself, such as in the devices unique identifier (ID), where some pre-allocated bytes in the ID identify to which group the device belongs. Another mechanism could be a mask that each device contains that identifies the grouping of the device. At the start of the transmission, the Network Element broadcasts to the device population which group it wants to wake up and communicate with the network. Using grouping schemes like this allows the system to effectively prioritize which groups of devices talk and at what time.

In FIG. 4A, two periods for each group are identified, period “m1” which is the time for a group of DS pulses, and period “m2” which is the time between adjacent groups of DS pulses; each period “m1,” “m2” is designed based on the duty factor and the latency requirement of the system and devices in the group. Each DS pulse within a group also has a period “P” and a pulse length “T.” In some embodiments, “m1” and “m2” are unique to a group; that is, no two groups have the same “m1” and/or “m2”. In FIG. 4A, all DS signals have the same period “P”, but each group of DS signals has a different period “m1” and the groups wake up at different times based on the period “m2”. The period “m1” can be increased to allow more devices in a group; however, this may result in an increased DS pulse period “P” and also increased “m2” latency, which is undesired in some embodiments, since it is desirable to maintain the duty factor sufficiently small, e.g., less than 1%, to conserve power. For example, for Group n−1, the corresponding latency (“m2”) in the above case is 10 seconds at 1% duty factor, and the corresponding latency (“m2”) increases to 100 seconds at 0.1% duty factor. To avoid this constraint, the group wake-up call architecture is categorized, e.g., as shown in Table 1.

To minimize a wake-up collision (overlap) event between devices in a group, “m2” is a prime number (e.g., 2, 3, 5, 7, 11, 13, 17, 19, 23, etc.). By using a prime number for “m2”, the least common multiple (LCM) is maximized, so that the overlap probability is minimized.

FIG. 4B shows an exemplary subgroup wake-up process architecture for “Group n” from FIG. 4A. Devices in the same group are assigned to a different subgroup 1, 2, . . . k−1, k in order to maximally utilize the communication resource. Each subgroup has at least one key value K (illustrated as a solid pulse, whereas the other pulses are illustrated in phantom), which corresponds to the time they turn on in order to receive a DS signal. In the example of these subgroups, all subgroups 1, 2, . . . k−1, k have the same period “n1” and “n2,” where “n1” is the time for a key value DS pulse, and “n2” is the time between adjacent key DS pulses. In this particular example of FIG. 4B, “n1” is 1 and “n2” is 6. In general, all subgroups in a group will have the same period “n1” and “n2.”

Returning to FIG. 4A, each group (e.g., Group 0, Group 1, . . . Group n) has its own DS signal period “m1,” as indicated above. When an overlap happens between groups, a higher group number may take the priority, which results in those devices with a lower priority having to wait for the next DS pulse. In some embodiments, however, multiple groups may have the same period “m1” and period “m2,” but with a time shift to inhibit any overlap. This categorized group wake-up call architecture substantially increases the device node capacity. In principle, the effective duty factor may be close to 100% making, e.g., about 400 wake-up calls per second, or 1.4 million wake-up calls per hour, for each home cell, depending on the periods “m1”, “m2” and “P” and pulse length “L.” Multiple frequency channels can be dedicated to this DS process to further increase the node capacity. A unique paging channel can be used to simplify the DS process. Using the paging channel, a string of device ID's is broadcast, either constantly or almost constantly.

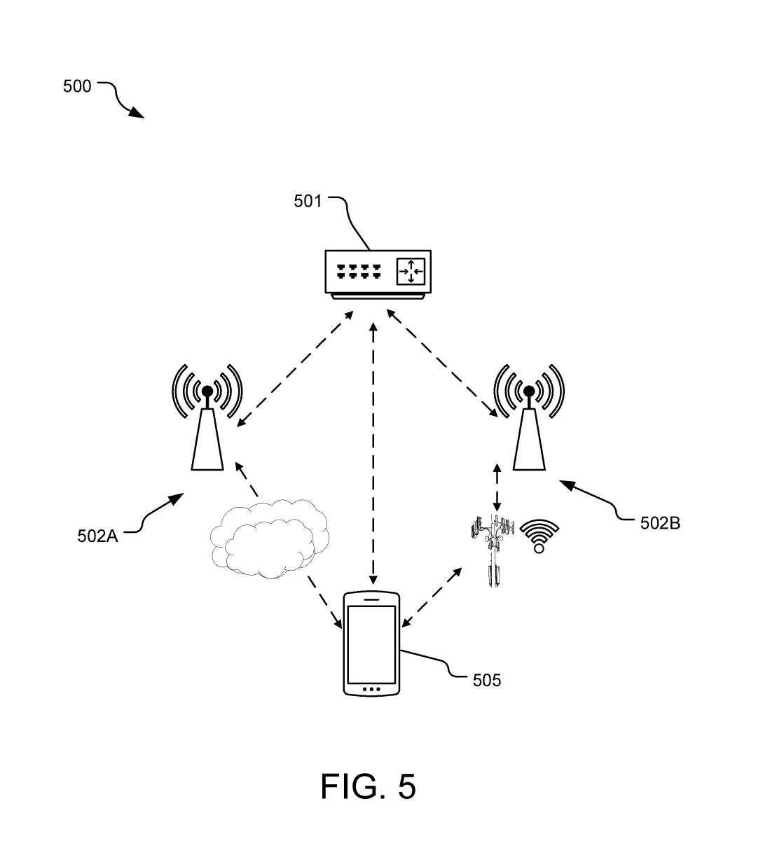

FIG. 5 depicts a system 500 incorporating an “On Demand” or direct control mechanism, in which a network or other LP_WAN control device initiates a call to a device using the device synchronization mechanism of FIGS. 4A and 4B, thus waking up a specific device when the system or end user needs to get data, e.g., sensory or location information, from that device. With this system 500, unnecessary communication traffic, which is undesired because it increases node density, is substantially reduced.

In FIG. 5, the system 500 has an LP_WAN-based IoT device 501, a direct control LP_WAN network 502A and an indirect control LP_WAN network 502B, and a control device 505, in this embodiment, a smartphone (e.g., an iOS or an Android or Windows based phone). For the direct control LP_WAN network 502A, device 501 is connected to the control device 505 through a backend backhaul network, e.g., a “cloud.” Indirect control LP_WAN network 502B is integrated with a cellular and/or WiFi network, with a handshake between protocols.

The LP_WAN device 501 initiates a call to cell phone 505 when desired and typically initiated by the user; either or both direct control network 502A and indirect control network 502B can be used. The frequency of the “On Demand” call may vary from a few seconds to a few weeks or months, depending on use cases of LP_WAN. Control device 505 can directly communicate with device 501 when device 501 is within communication distance of either network 502A, 502B.

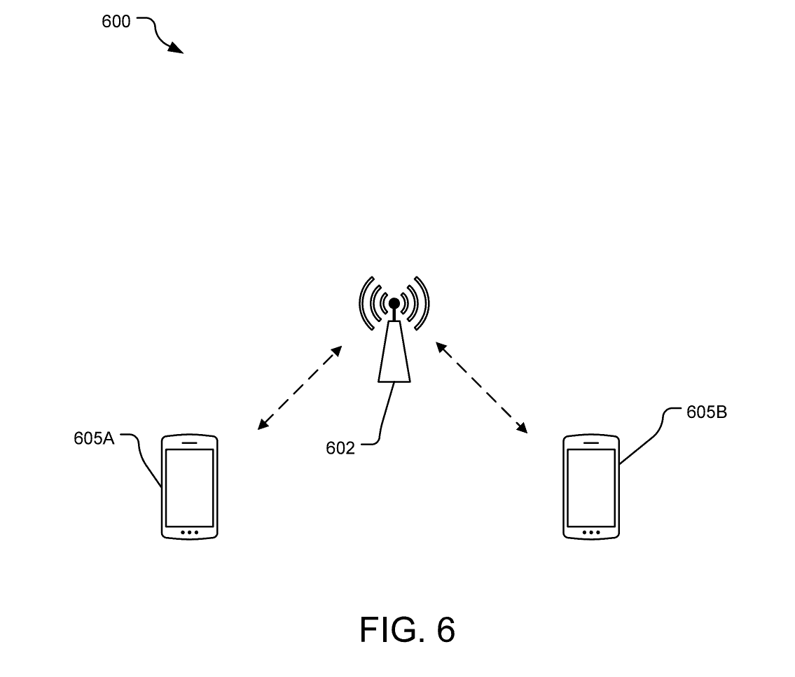

FIG. 6 shows a system 600 having two control devices, in particular, smartphones 605A, 605B (either or both being, e.g., an iOS or an Android or Windows-based phone) as LP_WAN controllers for an LP_WAN network 602. One smartphone, e.g., phone 605A, is a dongle LP_WAN controller 605A, and the other, e.g., phone 605B, is an embedded LP_WAN controller 605B. For a dongle controller 605A, an extra battery charger can be integrated using a parallel interface such as an audio jack or USB interface. To enable the categorized group wake-up calls as described above in reference to FIGS. 4A and 4B, a LP_WAN network 602 with a higher data payload option is preferred.

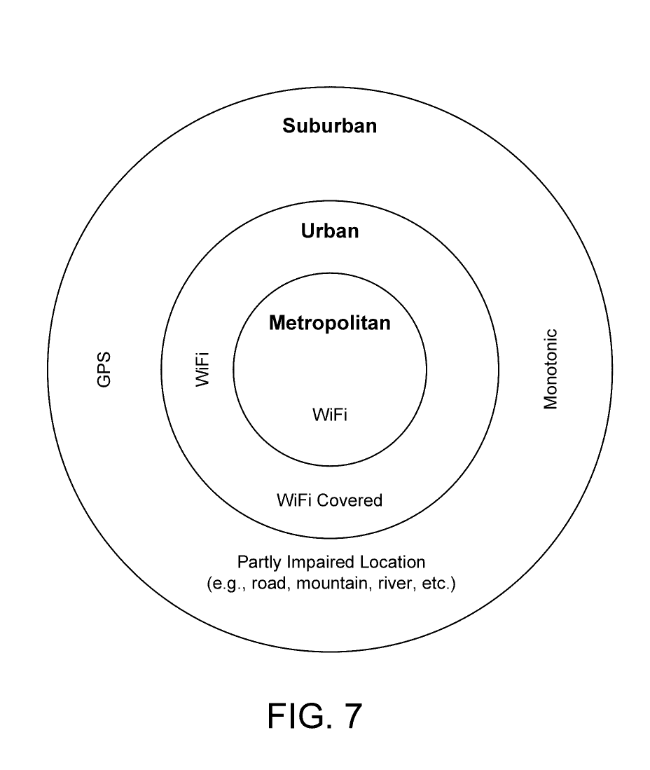

FIG. 7 shows a general topology of common location fix infrastructures available in metropolitan, urban and suburban areas. WiFi is widely available in metropolitan areas and, although its coverage is extending rapidly into urban areas and that coverage is good, WiFi is not readily available in suburban areas and especially rural areas (not shown in FIG. 7). WiFi based location accuracy is quite good (e.g., <50 m), and a power consumption for WiFi fingerprinting is moderate (e.g., 20 mA*2 sec=0.001 mAH per location fix).

A GPS (satellite based Global Positioning System) can be used as a location fix where no WiFi fingerprinting is readily available, such as in suburban areas, rural areas, or in any remote or hidden location, as long as a GPS signal is available with a direct line of sight to satellite(s). However, (standalone) GPS consumes relatively high amounts of power (e.g., 30 mA*240 sec=2 mAH per location fix), which is significantly higher than that of WiFi fingerprinting. Because of the high power consumption by GPS systems, it is desired to use GPS in situations having a short operation period, an infrequent location fix application, or as a back-up or secondary option.

Other readily available infrastructures for location fix include low energy Bluetooth (LBE), LAN (local area network) and PAN (personal area network), each which can be present in metropolitan areas, urban areas suburban areas, and/or rural areas, depending on the installation.

When an assisted location fix (such as a WiFi-assisted location fix, a GPS-assisted location fix, an LBE-assisted location fix, and/or other LAN or PAN-assisted location fix) is not available, a network-based (e.g., monotonic-based) location fix can be used. In almost all systems of this disclosure, a network-based (e.g., monotonic-based) location fix is available as a back-up, especially for a nationwide operation.

However, a network-based location fix requires additional infrastructure burden, sometimes as much as at least 50% more than a conventional LP_WAN case without a location fix. In an urban or metropolitan area, LP_WAN suffers from severe RF attenuations due to buildings and other obstacles. To counteract these issues, a LP_WAN design can incorporate many metropolitan (or metro) cells, such as femto cells, pico cells, and/or micro cells, that might provide only a few tens to hundreds meters in coverage.

In one embodiment of this disclosure, metro cells are not used in a network-based location fix process, because metro cell areas are well covered by WiFi coverage areas. Additionally, it is common that metro cells are frequently added, modified and updated, it can be a huge task to update any position determination engine (PDE) server data sufficiently frequently to include all correct metro cell data. Thus, location accuracy of network-based location fix, when using metro cells, can be inaccurate and poor in metropolitan and urban areas.

When there is no location fix available from either an assisted location fix or a network-based location fix, home cell information may be used for ranging (e.g., location) information. However, in general, as accuracy of home cell location increases, power consumption also increases. Therefore, it is important to choose the most suitable location fix method and a system that seamlessly supports the selection. Each location fix method and algorithm can be categorized by the type of applications and hardware features.

In an alternate embodiment, metro cells that are equipped with GPS position sensing devices are used in a location determination fix process. A metro cell with GPS position sensing allows the metro cell to determine its own location, such as when moved to a different location. Hence, the metro cell would periodically update the PDE with its location (e.g., it could be as simple as the metro cell registering its location every time it is powered up and periodically thereafter). This location information, together with the location information from other cells and the signals received from the device, is used by the PDE to compute the location of the device.

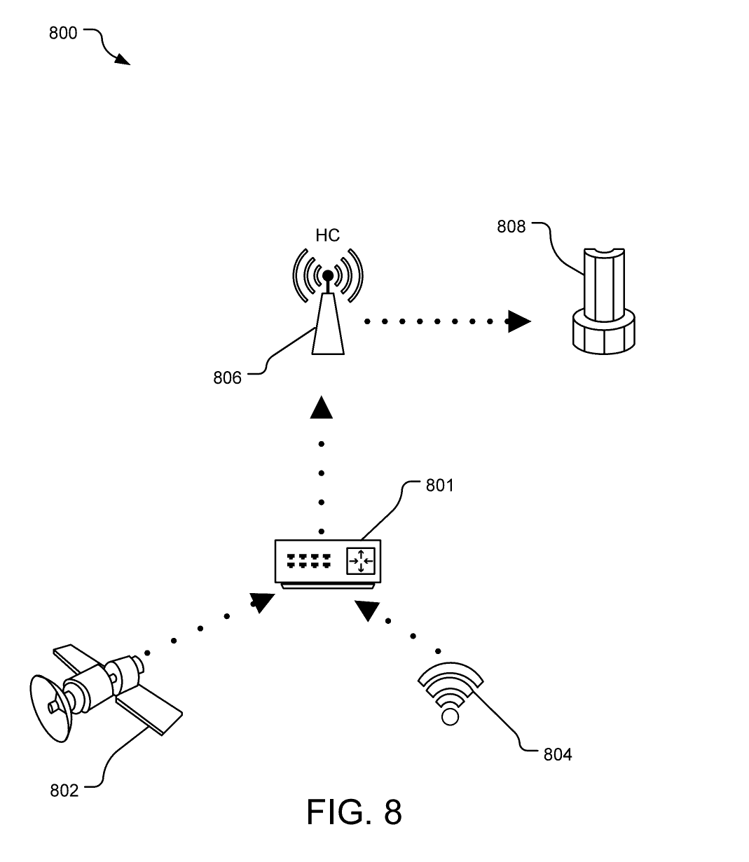

FIG. 8 shows a system 800 having both GPS-assisted location fix method and WiFi-assisted location fix method. A device 801 is shown receiving a location fix from a satellite-based GPS network 802 and from a WiFi network 804. Also shown is a cellular home cell (HC) 806 and a server 808.

With GPS-assisted location fix, device 801 consumes a non-trivial amount of power during each location fix. For example, if each time it takes about 4 minutes of fix time, this corresponds to a power consumption of 2 mAh per each location fix (i.e., 30 mA*240 seconds=2 mAh), in addition to about 300 mAh of regular calibration process on a weekly basis. Thus, a daily location fix by GPS-assisted fix requires more than 1,000 mAh of power per year.

Conversely with WiFi-assisted location fix, device 801 consumes much less power than with a GPS-fix, due to a much shorter location fix time using a WiFi fingerprinting method. In a WiFi fingerprinting method, device 801 picks up WiFi signals with SSID, MAC address, and/or RSSI value from the surrounding WiFi network 804, which usually takes less than 2 seconds. Therefore, each location fix requires less than 0.1 mAh (120 mA*2 seconds=0.067 mAh). Thus, a daily location fix by a WiFi fingerprinting method requires less than 25 m Ah of power per year. An hourly location fix will require a total annual power consumption less than 600 mAh.

At least because of power consumption, the WiFi-assisted location fix is preferred over GPS-assisted location fix, unless however, a location accuracy better than 5 m is desired and/or power consumption is not an issue (e.g., the system operates only a short period of time (e.g., much less than a year) or a frequent battery replacement is possible).

A network-based location fix can be also realized by Time of Flight (TOF) or Time Difference of Arrival (TDOA) using one-way ranging or two-way (round trip) ranging. By synchronizing the system with one-way ranging, an accurate location calculation can be made. For two-way ranging, the system does not have to be synchronized because the receiving device can backscatter the RF signal, thus obtaining an accurate location. During this process, though, the device will have to calculate the process time to accurately calculate the total traveling time to give accurate ranging information.

A frequency modulation method, such as CHIRP Spreading Spectrum (CSS), can be included in the system. After ranging information is gathered from multiple gateways or networks, frequency modulation can be used to avoid collisions during the location fix process. A higher frequency bandwidth can enhance the location accuracy by splitting the bandwidth into multiple sub-bands. A multiplex processing can be conducted to provide enhanced ranging information. A triangulation calculation is then performed to get location information from a set of ranging information. A network-based location fix can be sensitive to environment due to reflection, diffraction, attenuation, and multi-paths, all which can influence the ranging information, which is more severe in urban and metropolitan areas. Therefore, it is recommended to use an assisted location fix and use the network-based location fix as a backup, unless an accurate location is not required.

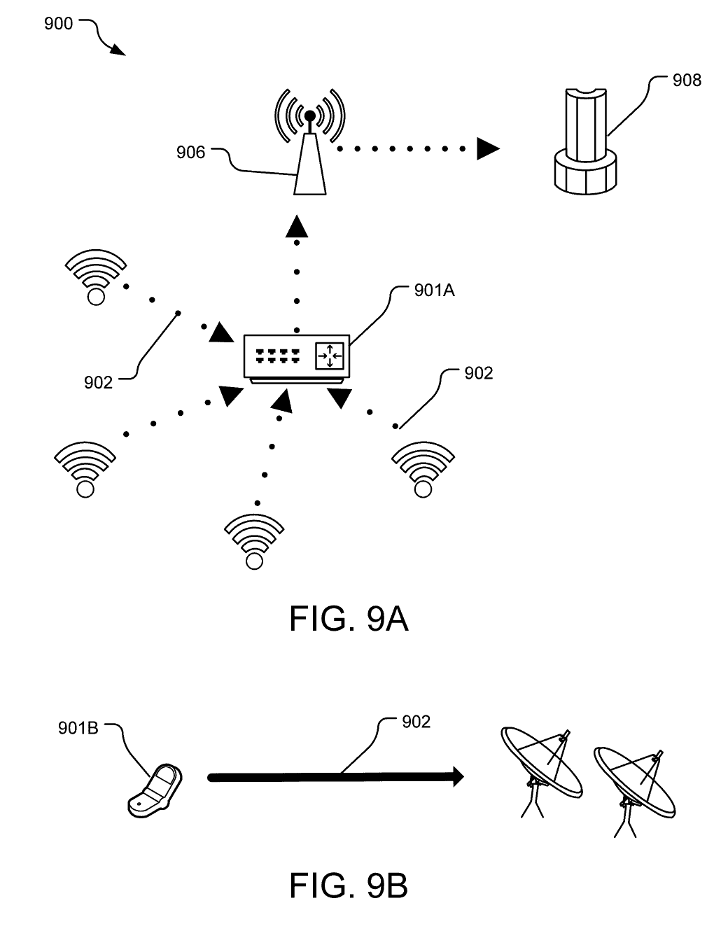

FIG. 9A shows a schematic of a WiFi-assisted location fix system 900. Also shown in a cellular home cell (HC) 906, and a server 908. Multiple WiFi signals 902 are collected by a device 901A. As shown in FIG. 9B, each WiFi signal 902 carries multiple identifications for the WiFi device 901B, similar to device 901A, such as SSID (32 bytes), MAC address (6-8 bytes), and RSSI value (1 byte). It is not unusual that 10 or more WiFi signals 902 are captured in a fingerprinting process; with each capture, the device 901A, 901B transmits an enormous amount of data to the network. For example, if 10 WiFi signals are captured, then more than 400 bytes of data are transmitted, which is beyond conventional LP_WAN's design scope. To address this issue, truncated fingerprinting can be utilized.

With a truncated fingerprinting method, a main group of WiFi signals are selected (e.g., no more than 2 signals) and a sub group of WiFi signals are selected (e.g., no more than 4 signals) according to an RSSI value received. As an example, for the main group, the device transmits the MAC address (8 bytes) and RSSI value (1 byte) for a total of 9 bytes, and for the sub group, the device transmits the last 2-4 digits of MAC address (8-16 bytes), thus transmitting 17-25 bytes. For such a truncated fingerprinting, the system manages the last 2-4 digits of the MAC address in a neighboring WiFi database. Regardless of the number of WiFi signals captured, using a truncated fingerprinting method, a device transmits less than 32 bytes.

Mobile hotspots can be screened and removed from the fingerprinting process.

To overcome the scenario where newer, stronger and/or undocumented WiFi access points might prevent or hinder information from being transmitted from known access points, a scheme can be created where the first time the WiFi data is being transmitted, the full data set of WiFi information is transmitted (rather than using the truncated fingerprinting method), the device then “remembers” the WiFi information and on subsequent location requests or transmissions, it indicates that there is no change in location if the same WiFi information is detected by the device. With no changes detected, the system then uses the truncated fingerprinting method, sending the reduced WiFi information. If any change is detected, a fresh (full) set of WiFi location is transmitted.

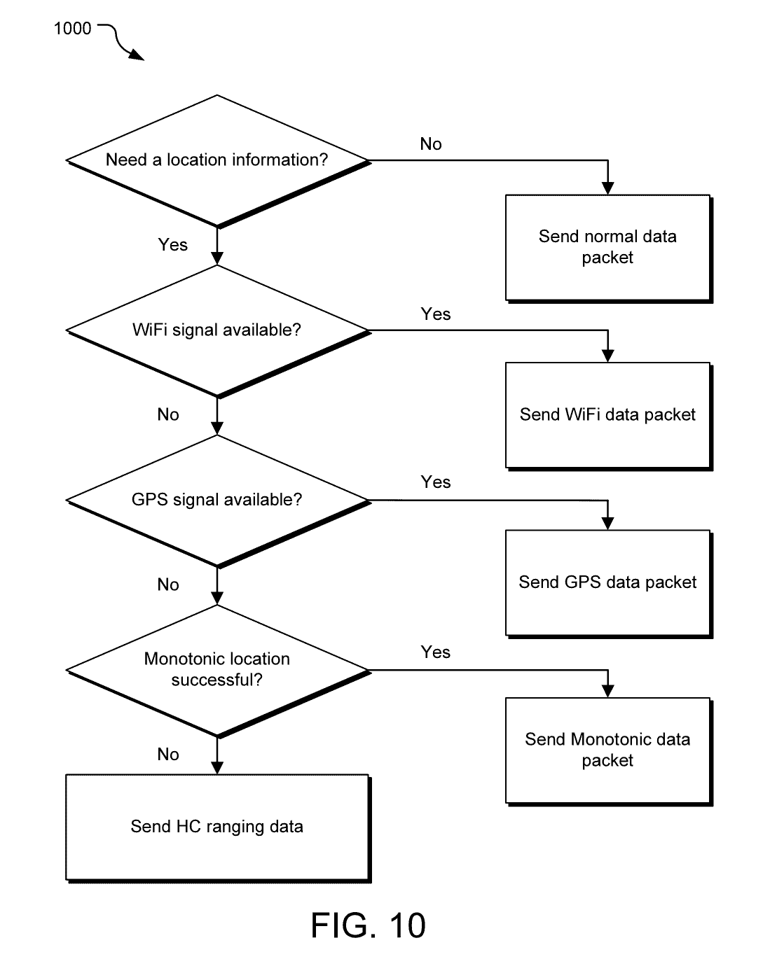

Stepwise, FIG. 10 shows a location fix methodology or algorithm 1000 for a device that is both WiFi- and GPS-enabled, with the WiFi being the primary or main location fix method and the GPS being the secondary or backup location fix. When neither WiFi nor GPS fix are available, a network-based (monotonic) location fix provides location information, supplemented by home cell (HC) ranging information.

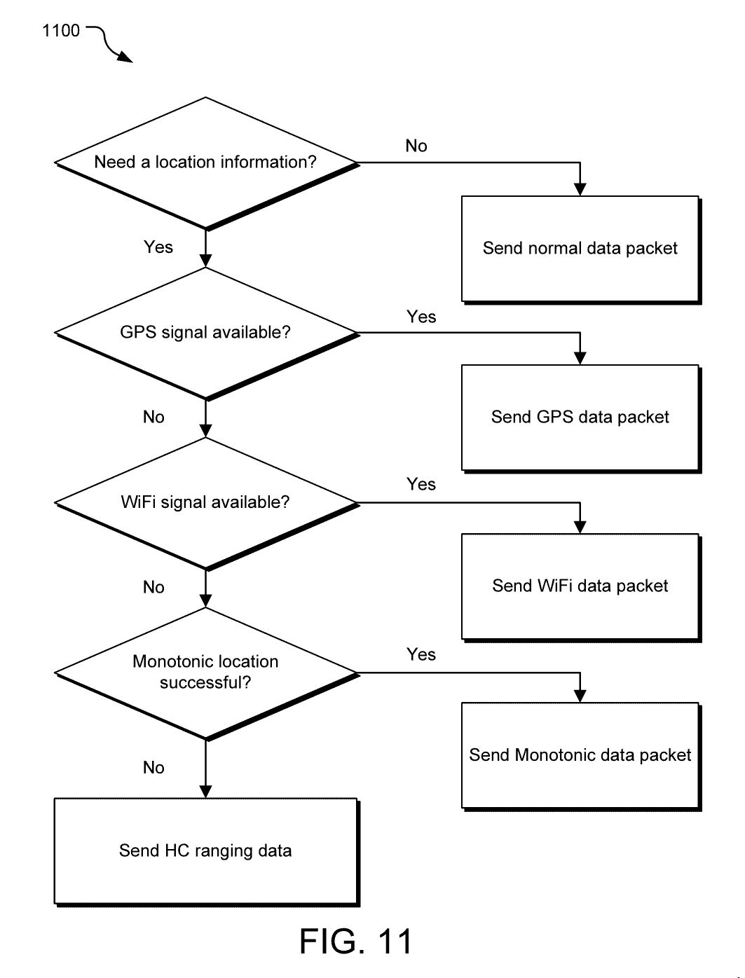

FIG. 11 similarly shows, stepwise, a location fix methodology or algorithm where both WiFi and GPS are enabled, and GPS acts as a main location fix method and WiFi serves as a backup. When neither GPS nor WiFi fix are available, then a network-based (monotonic) location fix provides location information, supplemented by home cell (HC) ranging information.

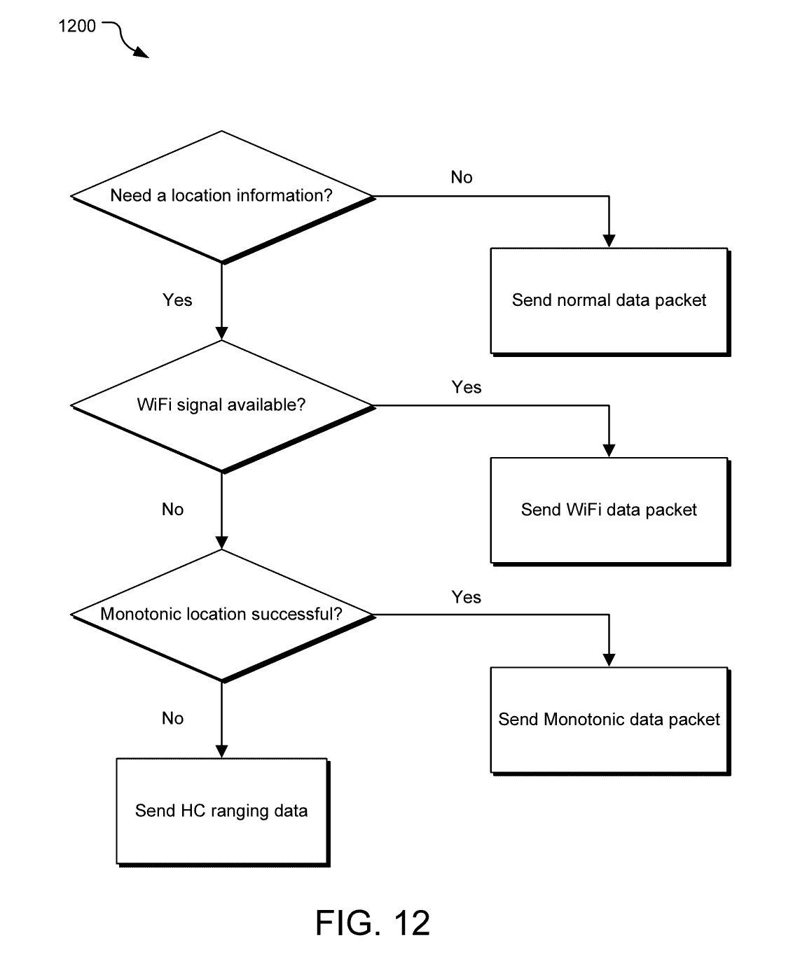

FIG. 12 similarly shows, stepwise, a location fix methodology or algorithm with a WiFi-only device. For occurrences when the WiFi location fix is unavailable or has otherwise failed, a network-based (monotonic) location fix provides location information supplemented by home cell (HC) ranging information.

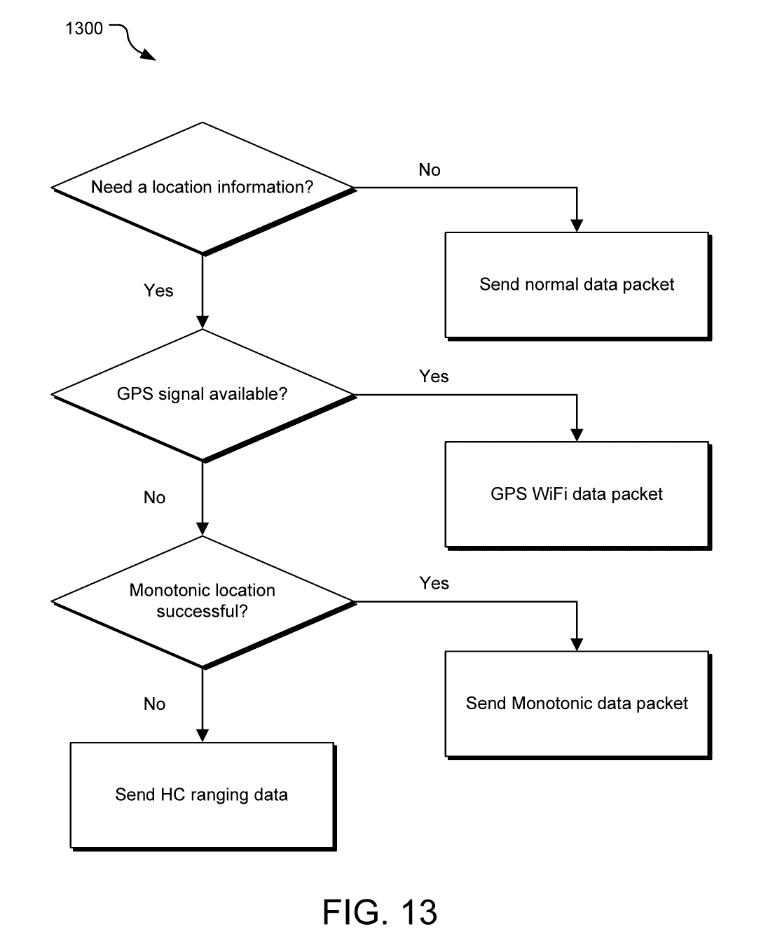

Similarly, FIG. 13 shows, stepwise, a location fix methodology or algorithm with a GPS-only device. For occurrences when the GPS location fix is unavailable or has otherwise failed, a network-based (monotonic) location fix provides location information followed by home cell (HC) ranging information.

An alternative location fix method could utilize resources such as an indoor location service (LB S) including Ultra Wideband (UWB), CHIRP, WiFi, ZigBee, and LBE-based LBS solution as a method to fix a location. Any of these location resources can be incorporated into any of the systems and methods of FIGS. 10-13 with a modified algorithm without changing the system protocol, since the location fix is done by a device level.

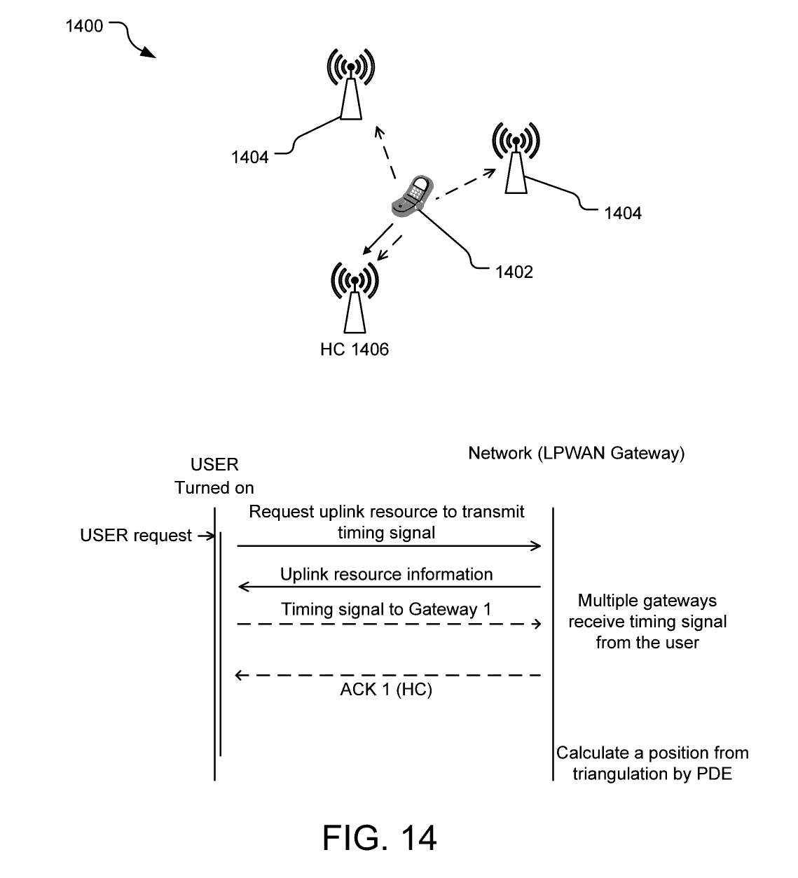

FIG. 14 illustrates an example sequence of a user requested network calculated (URNC) communication method using one-way LP_WAN. FIG. 14 has a device 1402 operably connected to multiple networks 1404 (in some implementations herein also referred to as a LP_WAN gateway, or merely a gateway), one of which is a home cell (HC) 1406 assigned during the device synchronization process (DS) described earlier.

A communication initiation or request is made by device 1402 (USER) to HC 1406; the device 1402 sends a request for an uplink resource to transmit a timing signal. The network 1404 replies with the requested uplink resource information. The device 1402 then sends a single trip transmission pulse with timing information to each allocated network 1404. The network 1404 provides an ACK signal after communicating with other pertinent networks 1404 in the background. Transmitting a timing signal is beneficial to validate synchronization accuracy. However, it may be omitted in case of a round trip ranging scheme. No wake-up process is required.

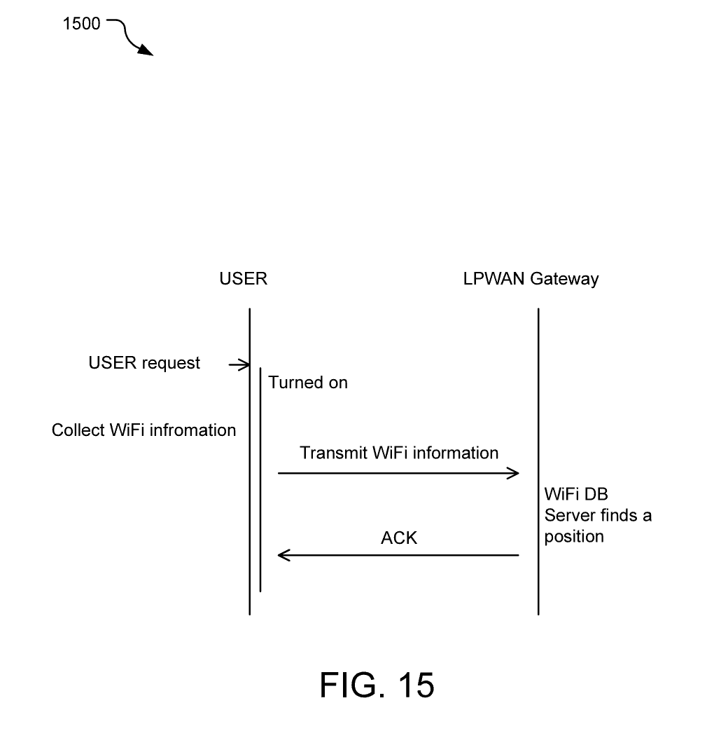

FIG. 15 illustrates an example detailed sequence of a device initiated (DI) communication URNC method 1500 using an assisted location fix. In method 1500, a communication request is made by a device (USER), for example to an HC that was assigned during the DS process. Both WiFi assisted and GPS-assisted location fix can be used, although method 1500 is illustrated using WiFi assist.

In method 1500, a communication request is made by a USER for a location fix. The device collects location information from available WiFi and transmits the WiFi information to a WiFi database server via an LP_WAN gateway (network), after which the LP_WAN gateway (network) sends and ACK back to the device. Transmitting a timing signal is beneficial to validate a synchronization event, but not critical.

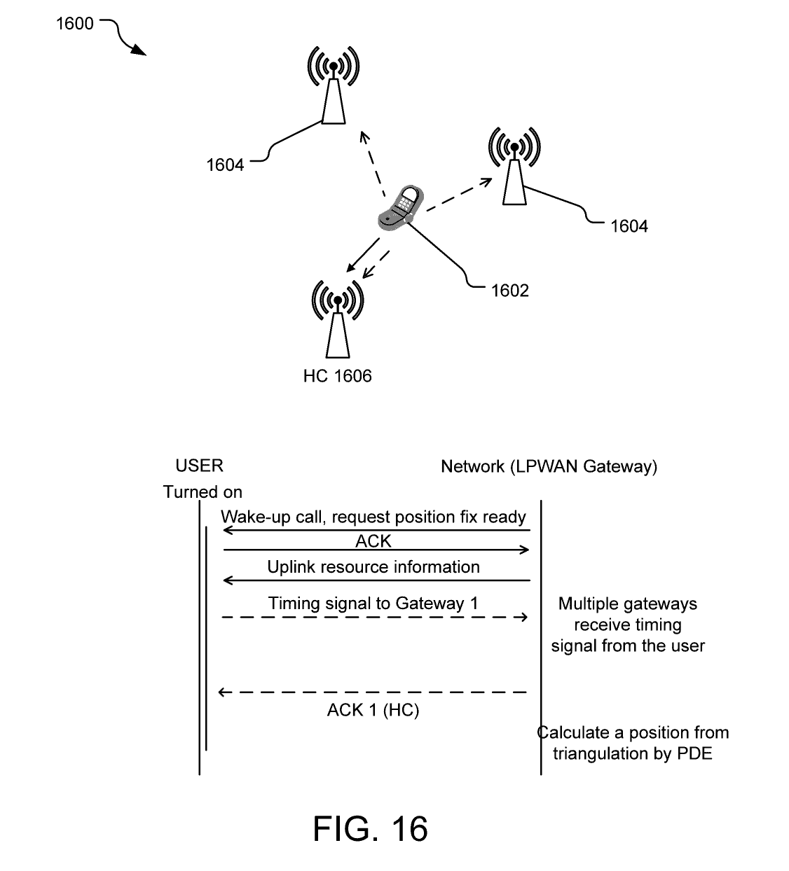

FIG. 16 illustrates an example sequence of a network initiated (NI) communication method 1600 using a network-based location fix method (NRNC). FIG. 16 has a device (USER) 1602 operably connected to multiple networks 1604, one of which is a home cell (HC) 1606 assigned during a DS process.

Seen in FIG. 16, a communication request is made by a network 1604 (also referred to herein as an LP_WAN gateway, or merely a gateway) to device (USER) 1602 which is then woken up (turned on) during the DS process. If the device 1602 is woken up, and ready, the device 1602 sends an ACK and request uplink resource to transmit a timing signal to the network 1604. The network 1604 replies with the requested uplink resource information. The device 1602 then sends a single trip transmission pulse with timing information to each allocated gateway (network 1604). Since there are multiple networks 1604 receiving timing information from the device 1602, a location of the device is determination by a triangulation method by the networks. Both single path and round trip ranging can be made. Transmitting a timing signal is beneficial to validate synchronization accuracy. However, it may be omitted in case of a round trip ranging scheme.

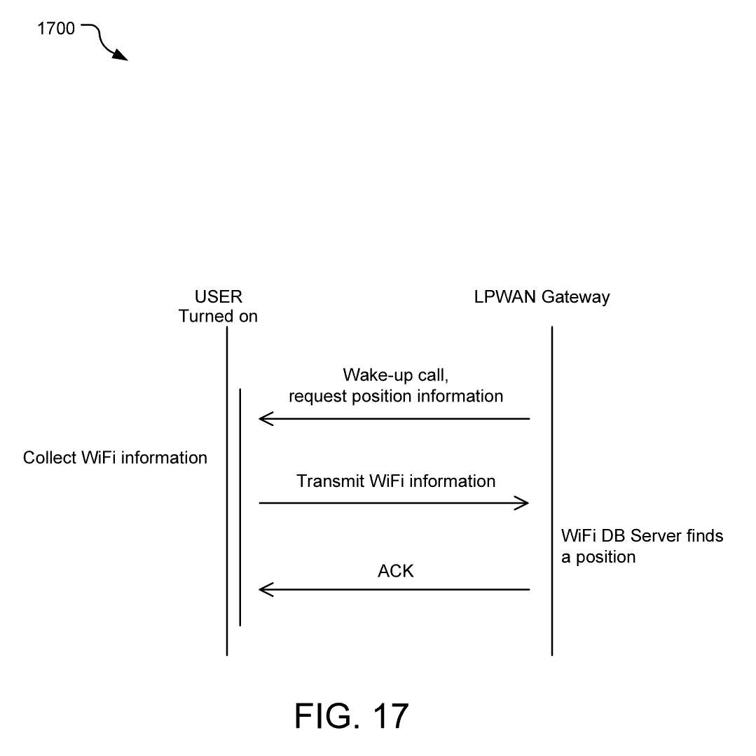

FIG. 17 illustrates an example detailed sequence of a network initiated (NI) communication NRNC method 1700 using an assisted location fix method. In method 1700, a communication request is made by a network (gateway) to a device (USER) which is woken up during the DS process. Both WiFi assisted and GPS-assisted location fix can be used, although method 1700 is illustrated using WiFi assist. Transmitting a timing signal is beneficial to validate synchronization event, but not critical.

In method 1700, a communication request is made by a network for a location fix. The network sends a wake-up call, and request position information. The device collects location information from available WiFi and transmits the WiFi information to a WiFi database server via an LP_WAN gateway (network), afterwhich the LP_WAN gateway (network) sends an ACK back to the device.

This NRNC communication method enables an “On Demand” or direct control capability at optimal power and communication resource overhead. This “On Demand” or “Direct Control” feature is beneficial in many applications such as ‘Smart Home’, ‘Smart Security’, ‘Smart Energy’, etc. This feature can also reduce the amount of data traffic by requesting data packet only when it is needed. Although this feature requires additional overhead such as “awake” signal generation, potential dedicated channels, etc., it can be optimized to create benefits than overhead.

The “On Demand” request can be implemented by a user on a device such as a “smart phone,” tablet, or other device having the capability of wireless communication and location identification. An LP_WAN dongle, which has a LP_WAN chipset, a microprocessor or microcontroller (CPU), and a circuit for drawing power from a digital audio signal (power circuit), could be plugged into the audio/earpiece jack of a device such as a smartphone to enable the smartphone to operate as LP_WAN terminal. The CPU of the dongle sends the information to the smartphone through the microphone input contact of the audio/earpiece jack. Once the data is received by the smartphone, it is transmitted via one the associated networks. A digital audio signal, constantly generated by the smartphone, provides power to the dongle via the power circuit. The power circuit converts the digital audio signal to stable DC power with the appropriate voltage for powering the dongle.

In another embodiment, a LP_WAN device is directly embedded into the smartphone or other device, creating a true IoT smartphone. In such an embodiment, a LP_WAN device can directly communicate with the smartphone or the smartphone could communicate with a LP_WAN tower.

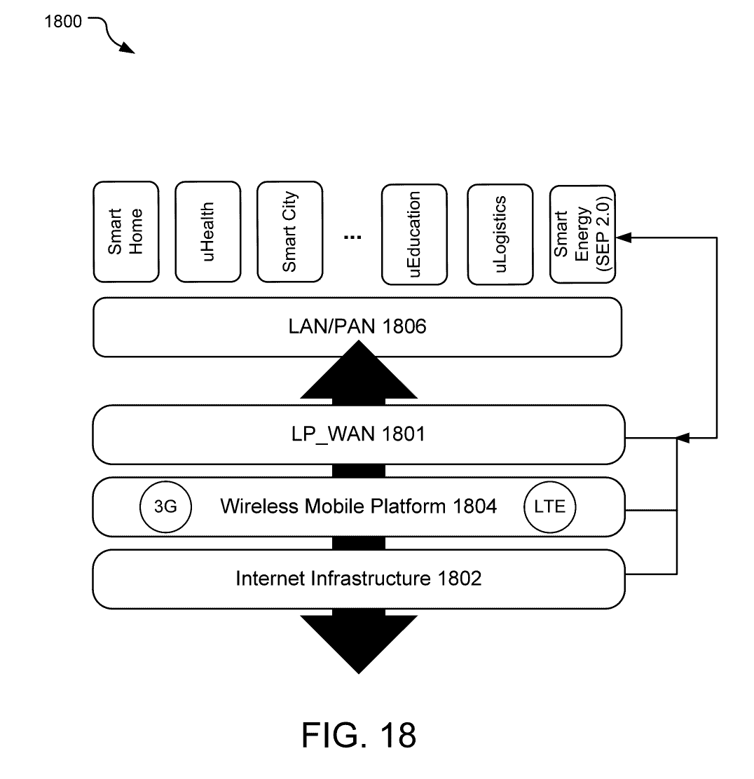

FIG. 18 depicts a novel IoT communication stack architecture 1800 where LP_WAN 1801 plays a critical role in combination with conventional wireless communication stacks such as a wired communication stack 1802 (internet infrastructure) and a wireless mobile platform 1804 (e.g., WiFi, 3G, LBE, etc.). As shown in FIG. 18, together, LP_WAN 1801, wired communication platform 1802 and wireless communication platforms 1804 support a local area network (LAN) or personal area network (PAN) 1806 that supports different service providers, such as those commonly and generically referred to as ‘Smart Home’, ‘UHealth’, ‘Smart City’, ‘uEducation’, ‘uLogistic’, ‘Smart Energy’, etc., that (prior to this disclosure) are currently serviced by existing network platform providers such as PAN, LAN, WAN. LP_WAN 1801 is a complementary option off-loading low data traffic from conventional wired communication stack 1802 thus balancing the communication bandwidth. With this scheme, massive connectivity of IoT devices can be managed.

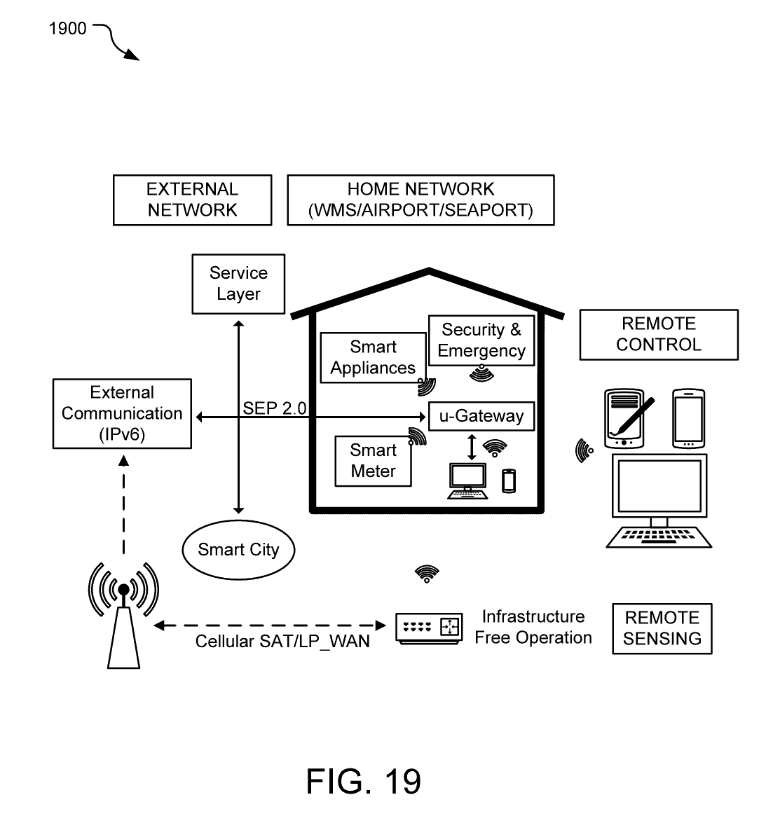

FIG. 19 shows a generic application as an example, where all communication stacks (such as from FIG. 18) are integrated and provide much needed services, for example, for a household. An LP_WAN network can be applied in any external network application such as external communication (IPv6), Smart City, a remote sensing application, and home (internal) network applications such as smart metering, smart appliances, security, etc. This organic integration also increases the application landscape itself otherwise not possible.

The above specification and examples provide a complete description of the structure and use of exemplary embodiments of the invention. The above description provides specific embodiments. It is to be understood that other embodiments are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

Since many embodiments of the invention can be made without departing from the spirit and scope of the invention, the invention resides in the claims hereinafter appended. Furthermore, structural or method features of the different embodiments may be combined and/or substituted in other embodiments.

What is claimed is:

1. A LP_WAN system comprising:
a wireless, Wi-Fi-enabled and GPS-enabled device;
a network comprising multiple network access points, one of which is a home cell for the device, the network connecting the device to a server; and
a location fix methodology including a WiFi-assisted location fix, a GPS-assisted location fix, and a network-assisted location fix, wherein the methodology includes the device transmitting data via the network to the server after the device has been activated, and the sever transmitting an acknowledgement to the device via the network after the data has been received, wherein the WiFi-assisted location fix and the GPS-assisted location fix are attempted prior to the network-assisted location fix.

2. The LP_WAN system of claim 1, wherein the WiFi-assisted location fix is attempted prior to the GPS-assisted location fix.

3. The LP_WAN system of claim 1, wherein the GPS-assisted location fix is attempted prior to the WiFi-assisted location fix.

4. The LP-WAN system of claim 1, wherein the location fix methodology is a device requested methodology.

5. The LP_WAN system of claim 4, wherein the device collects data after being turned on.

6. The LP-WAN system of claim 1, wherein the location fix methodology is a network requested methodology.

7. The LP_WAN system of claim 6, wherein the server sends a wake-up call to the device.

8. The LP_WAN system of claim 7, wherein the device collects data after being turned on.

9. The LP_WAN system of claim 1, wherein the device is a smart phone.

10. The LP_WAN system of claim 9, wherein the LP_WAN utilizes a dongle in a port of the smart phone.

11. The LP_WAN system of claim 10, wherein the port is a USB port or an audio jack.

12. A LP_WAN system comprising:
a wireless, Wi-Fi-enabled and GPS-enabled device;
a network comprising multiple network access points, one of which is a home cell for the device, the network connecting the device to a server;
a location fix methodology including a primary location fix selected from at least one of WiFi-assisted location fix, a GPS-assisted location fix, a low energy Bluetooth (LBE)-assisted location fix, and a personal area network (PAN)-assisted location fix, and a secondary network-assisted location fix; and
a home cell-based location ranging;
wherein the methodology includes the device transmitting data via the network to the server after the device has been activated, and the sever transmitting an acknowledgement to the device via the network after the data has been received, wherein a location fix is attempted via the primary location fix prior to the secondary network-assisted location fix, and if no primary or secondary location fix is obtained, attempting a home cell-based location ranging location fix.

13. The LP-WAN system of claim 12, wherein the location fix methodology is a device requested methodology.

14. The LP-WAN system of claim 12, wherein the location fix methodology is a network requested methodology.

15. The LP_WAN system of claim 14, wherein the server sends a wake-up call to the device.

16. The LP_WAN system of claim 12, wherein the device is a smart phone.

17. The LP_WAN system of claim 16, wherein the LP_WAN utilizes a dongle in a port of the smart phone.

18. The LP_WAN system of claim 17, wherein the port is a USB port or an audio jack.

19. A LP_WAN solution comprising:
a wireless, Wi-Fi-enabled and GPS-enabled device;
a first primary assisted location fix and a second primary assisted location fix, each assisted location fix being a standalone location fix; and
a secondary network-based location fix including home cell-based location ranging, wherein the first primary assisted location fix is one of a WiFi-assisted location fix and a GPS-assisted location fix and the second primary assisted location fix is the other of the WiFi-assisted location fix and the GPS-assisted location fix.

20. The LP-WAN solution of claim 19, wherein the first primary assisted location fix is the WiFi-assisted location fix and the second primary assisted location fix is the GPS-assisted location fix.

21. The LP-WAN solution of claim 19, wherein the first primary assisted location fix is the GPS-assisted location fix and the second primary assisted location fix is the Wi-Fi-assisted location fix.

22. The LP_WAN solution of claim 19, being a user requested, network calculated method.

23. The LP_WAN solution of claim 22, wherein the method is triggered by a time, motion, or an expected event.

24. The LP_WAN solution of claim 19, being a network requested, network calculated method.

25. The LP_WAN solution of claim 24, wherein the method includes waking the first primary assisted device using a device synchronization process.

26. The LP_WAN solution of claim 25, wherein the device synchronization process is done using a paging channel method, a fixed pulse length and period, or with a categorized group wake-up method to maximize the node capacity with an overlapped pulse following a pre-determined priority protocol according to its latency requirement.

27. The LP_WAN solution of claim 25, wherein during the device synchronization process, the device is in a sleep mode when there is no motion.

28. The LP_WAN solution of claim 24, wherein the solution includes a user initiating a network requested location fix.
